(19) United States
(12) Patent Application Publication
(10) Pub. No.: US 2007/0264979 A1
(43) Pub. Date: Nov. 15, 2007

(54) Method and system for registering IP address in portable Internet network when interworking with different types of network

(75) Inventors: Seongsoo Park, Gangseo-gu (KR); Donghahk Lee, Seongnam-si (KR); Wonsuk Chung, Seongbuk-gu (KR)

Correspondence Address: LAHIVE & COCKFIELD, LLP, ONE POST OFFICE SQUARE, BOSTON, MA, 02109-2127, US

(73) Assignee: SK Telecom Co., Ltd., Jung-gu (KR)

(21) Appl. No.: 11/410,360

(22) Filed: Apr. 25, 2006

(51) Int. Cl. H04Q 7/38; H04Q 7/22; H04M 3/42

(52) U.S. Cl. 455/414.1

(57) ABSTRACT

Disclosed is a method for registering an IP address in a Portable Internet network in interworking with a different type of network, which enables a communication service to be continued without change in an IP address of a personal subscriber station when the personal subscriber station moves to the Portable Internet network, the method including: (a) when the personal subscriber station accesses the Portable Internet network, receiving a registration request message from the personal subscriber station, the registration request message including both information on an IP assignment method by which an IP address has been assigned to the personal subscriber station in the different type of network, and information on an IP address assigned to the personal subscriber station; and (b) registering the IP address being used by the different type of network as the IP address of the personal subscriber station by using the IP address information.

### FIELD OF THE INVENTION

The present invention relates to a method and a system for registering an Internet Protocol (hereinafter, referred to as IP) address in a Portable Internet (hereinafter, referred to as PI) network when the Portable Internet network interworks with a different type of network, and more particularly to a method and a system for registering an IP address in a Portable Internet network when the Portable Internet network interworks with a different type of network, in which, when an existing network such as a Code Division Multiple Access (hereinafter, referred to as CDMA) 2000 network currently having a sufficient infra-structure interworks with the Portable Internet network, a Personal Subscriber Station (hereinafter, referred to as PSS) provides the Portable Internet network with information on an IP address used with a previous network, so that the Portable Internet network can continue a communication service with the previous network without changing an IP address.

### BACKGROUND OF THE INVENTION

With the rapid development of communication technology and the development of various content, various wireless communication services using a wireless network have been provided. The most basic wireless communication service is a wireless voice communication service for providing voice communication to mobile communication terminal users in a wireless manner, which has a characteristic of providing the service to the users regardless of time and place. Further, the wireless communication service supplements a voice communication service by providing a text message service. Recently, a wireless Internet service has emerged, which provides an Internet communication service to mobile communication terminal users through a wireless communication network.

With the development of mobile communication technology as described above, a service provided by a CDMA mobile communication system is being developed into a multimedia communication service capable of transmitting data such as circuit data and packet data, as well as voice data.

With the recent development of information communication, International Mobile Telecommunication (hereinafter, referred to as IMT)-2000, e.g., a CDMA 2000 1×, 3× and EV-DO, a Wideband CDMA (hereinafter, referred to as WCDMA), etc., has been commercialized, which corresponds to the 3^{rd} mobile communication system and has been established as a standard by an International Telecommunication Union-Radiocommunication (ITU-R). An IMT-2000 corresponds to a service capable of providing a wireless Internet service at a maximum transmission speed of 144 Kbps far faster than 14.4 Kbps or 56 Kbps, which is the data transmission speed supported by an Interim Standard (hereinafter, referred to as IS)-95A network or an IS-95B network, by means of an IS-95C network evolved from the existing IS-95A network and IS-95B network. In particular, an IMT-2000 service is used, so that the quality of an existing voice and Wireless Application Protocol (WAP) service can be improved and various multimedia services, e.g., Audio On Demand (AOD), Video On Demand (VOD), etc., can be provided at higher speeds.

Wireless Internet technology currently used across the world may be largely classified into the 3G cellular system based on the portable telephone network as described above and a Wireless Local Access Network (WLAN) based on IP-based packet transmission.

The existing cellular system supports excellent mobility and handoff, ensures a data transmission speed necessary for voice communication, and additionally supports a packet data service. However, the existing mobile communication system has drawbacks that service charges for the wireless Internet are high due to high base station construction cost, available content is restricted due to small size of the display on the terminal, and there is a limitation in ensuring a sufficient transmission speed for a packet data service.

In the case of the WLAN, a superior data transmission speed is attainable as compared with the cellular system. However, there may be a problem in mobility due to radio wave interference. Further, there is a limitation in providing a public service due to narrow service coverage, etc.

Accordingly, a Portable Internet service system has emerged, in order to support the mobility and handoff of the cellular system while providing a transmission speed as fast as that of the WLAN, and to provide an ultra high-speed wireless Internet service at low cost.

According to a Portable Internet service also referred to as a 3.5G, a user can access the Internet by using various types of portable PSSs, such as notebooks, Personal Digital Assistants (hereinafter, referred to as PDAs) and handheld PCs, in stationary indoor and outdoor environments and mobile environments involving movement at various speeds, thereby using various information and content. Further, the Portable Internet service provides mobility of 60 km/h, which is an IP-based wireless data service having an upload/download asymmetric transmission characteristic in which a download transmission speed is 24.8 Mbps and an upload transmission speed is 5.2 Mbps.

A Portable Internet system uses a 2.3 GHz frequency band, and employs an Orthogonal Frequency Division Multiple Access (hereinafter, referred to as OFDMA), which are parts of the next generation core technology, a Time Division Multiple Access (hereinafter, referred to as TDMA), a Time Division Duplexing (hereinafter, referred to as TDD), etc. The OFDMA/TDMA is a multiple access scheme similar to the TDMA which allocates all sub-carriers in the entire bandwidth to one user during a predetermined time period and then allocates all sub-carriers to another user during the subsequent predetermined time period. Further, for efficient use of radio resources, standardization for employing technology, such as an Adaptive Modulation coding (AMC), a Multi-Input Multi-Output (MIMO), and a smart antenna, is currently under process.

With the introduction of the new system as described above, an interworking function between an existing network and a new network is required. Since users request various services not bound to a specific network type, an interworking network for satisfying the requirements of the users has been constructed. For the construction of such an interworking network, research into 3G mobile communication and WLAN has been actively pursued. However, these networks have been independently developed and involve different standards. Accordingly, for an interworking between these networks, it is necessary to consider various items such as architectures, protocol structures, mobility, Quality of Service (QoS), authentication, security and accounting, and further, revise and supplement for each item should be accompanied.

From the perspective of a network, a 3G-WLAN interworking scheme may be classified into a loosely-coupled interworking scheme and a tightly-coupled interworking scheme.

According to the loosely-coupled interworking scheme, a 3G network and a WLAN separately exist and provide independent services, and a gateway for the interworking of authentication and accounting is additionally provided in order to perform a roaming service which requires interworking. Further, the mobility between the 3G network and the WLAN is provided based on a Mobile IP (hereinafter, referred to as MIP).

According to the tightly-coupled interworking scheme, a WLAN Access Point (AP) is wired to a 3G data core network and enables integrated user authentication/accounting and integrated network management to be performed. Further, it is easy to provide a continuous service, as compared with the MIP-based loosely-coupled interworking scheme.

The loosely-coupled interworking scheme and the tightly-coupled interworking scheme may also be applied to a 3G network such as a CDMA 2000 network, and a Portable Internet network. However, in a system employing the loosely-coupled interworking scheme, 3G network users and Portable Internet users are independently authenticated, and accounting and mobility support management policies are separately maintained. In such a case, it is necessary to introduce a mobile IP function in order to support mobility between networks. Further, in a system employing the tightly-coupled interworking scheme, a 3G core network is directly integrated with a Portable Internet network. That is, the Portable Internet network is directly connected to apparatuses of the 3G core network. Accordingly, the Portable Internet network functions as one 3G access network in the 3G core network.

In the Portable Internet network, an IP address must be basically assigned to a PSS. Therefore, when the Portable Internet network interworks with a different type of network, processing of an IP address used for the different type of network may be an issue. Herein, if the two networks interwork with each other without change in an IP address, connectivity of a service is maintained, which results in efficiency. Accordingly, it is necessary to provide an interworking scheme that does not require the change in an IP address. For this, definition of protocols is also necessary.

### SUMMARY OF THE INVENTION

Accordingly, the present invention has been made to solve the above-mentioned problems occurring in the prior art, and an object of the present invention is to provide a method and a system for registering an IP address in a Portable Internet network when the Portable Internet network interworks with a different type of network, in which, when an existing network such as a CDMA 2000 network currently having a sufficient infra structure interworks with the Portable Internet network, a PSS provides the Portable Internet network with information on an IP address being used by a previous network, so that the Portable Internet network can continue a communication service with the previous network without change in an IP address.

In accordance with one aspect of the present invention, there is provided a method for registering an IP address in a Portable Internet network when the Portable Internet network interworks with a different type of network, which enables a communication service to be continued without change in an Internet Protocol (IP) address of a personal subscriber station when the personal subscriber station moves from the different type of network to the Portable Internet network, the method including the steps of: (a) when the personal subscriber station accesses the Portable Internet network from the different type of network, receiving a registration request message from the personal subscriber station, the registration request message including both information (IP assignment method information) on an IP assignment method by which an IP address has been assigned to the personal subscriber station in the different type of network, and information (IP address information) on an IP address assigned to the personal subscriber station; and (b) registering the IP address being used by the different type of network as the IP address of the personal subscriber station in the Portable Internet network by means of the IP address information included in the registration request message.

In accordance with another aspect of the present invention, there is provided a system for registering an IP address in a Portable Internet network when the Portable Internet network interworks with a different type of network, which enables a communication service to be continued without change in an Internet Protocol (IP) address of a personal subscriber station when the personal subscriber station moves from the different type of network to the Portable Internet network, the system including: a radio access station for receiving a registration request message from the personal subscriber station when the personal subscriber station accesses the Portable Internet network from the different type of network, the registration request message including both information (IP assignment method information) on an IP assignment method by which an IP address has been assigned to the personal subscriber station in the different type of network, and information (IP address information) on an IP address assigned to the personal subscriber station; and an access control router for receiving the IP address information included in the registration request message from the radio access station, and registering the IP address being used by the different type of network as the IP address of the personal subscriber station in the Portable Internet network by means of the received IP address information.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a network structure for a loosely-coupled interworking scheme between a Portable Internet network and a different type of network according to a preferred embodiment of the present invention;

FIG. 2a is a diagram partially illustrating the format of a registration request message according to the prior art;

FIG. 2b is a diagram partially illustrating the format of a registration request message according to a preferred embodiment of the present invention;

FIG. 3 is a block diagram illustrating a network structure for a tightly-coupled interworking scheme between a Portable Internet network and a different type of network according to a preferred embodiment of the present invention;

FIG. 4 is a flow diagram schematically illustrating a process for registering an IP address in a Portable Internet network when the Portable Internet network interworks with a different type of network according to a preferred embodiment of the present invention; and

FIG. 5 is a ladder diagram illustrating an originating procedure on a PSS when a Portable Internet network interworks with a different type of network according to a preferred embodiment of the present invention.

### DETAILED DESCRIPTION OF THE PREFERRED EMBODIMENTS

Hereinafter, a preferred embodiment of the present invention will be described with reference to the accompanying drawings. In adding reference numerals to components of each drawing, the same reference numerals are used to designate the same or similar components, and so repetition of the description on the same or similar components will be omitted. In the following description of the present invention, a detailed description of known functions and configuration incorporated herein will be omitted when it may make the subject matter of the present invention unclear.

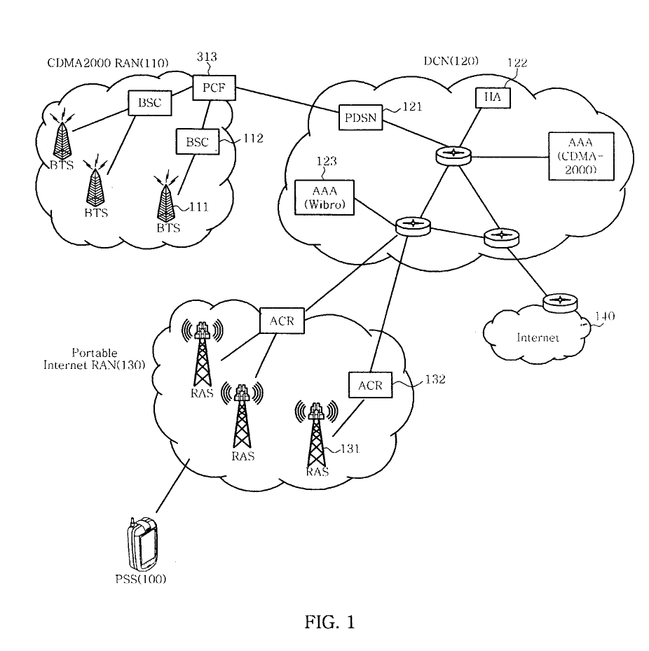

FIG. 1 is a block diagram illustrating a network structure for a loosely-coupled interworking scheme between a Portable Internet network and a different type of network according to a preferred embodiment of the present invention.

As illustrated in FIG. 1, the network structure according to the preferred embodiment of the present invention may include a CDMA-2000 Radio Access Network (hereinafter, referred to as RAN) 110, which corresponds to the different type of network, a Data Communication Network (hereinafter, referred to as DCN) 120, a Portable Internet RAN 130, etc. The CDMA-2000 RAN 110 may include elements such as a Base Transceiver Station (hereinafter, referred to as BTS) 111, a Base Station Controller (hereinafter, referred to as BSC) 112, a Packet Control Function (hereinafter, referred to as PCF) 115, etc. The DCN 120 may include elements such as a Packet Data Serving Node (hereinafter, referred to as PDSN) 121, a Home Agent (hereinafter, referred to as HA) 122, an Authentication, Authorization, Accounting (hereinafter, referred to as AAA) server 123, etc. The Portable Internet RAN 130 may include elements such as Radio Access Stations (hereinafter, referred to as RASs) 131, an Access Control Router (hereinafter, referred to as ACR) 132 for accommodating the RASs 131.

When the Portable Internet network interworks with the different type of network, the present invention provides a system for performing an IP registration without change in an IP address, and an IP registration method using the same. Herein, the different type of network includes a CDMA-2000 network, a Global System for Mobile (hereinafter, referred to as GSM) network, a WCDMA network, a WLAN network, etc., but is not limited to these networks. In the present specification, the CDMA-2000 network is exemplified as the different type of network for the purpose of description and understanding of the present invention, but it goes without saying that the different type of network is not limited to the CDMA-2000 network.

A PSS 100 according to the preferred embodiment of the present invention represents a mobile communication terminal that accesses a Portable Internet system according to the preferred embodiment of the present invention, and uses an ultra high-speed wireless Internet service. The PSS 100 performs a low power Radio Frequency (RF)/Intermediate Frequency (IF) module and controller function, a Media Access Control (hereinafter, referred to as MAC) frame variable control function according to service characteristics and radio wave conditions, a handoff function, authentication and encryption function, etc.

When the PSS 100 according to the preferred embodiment of the present invention accesses the Portable Internet RAN 130 from the CDMA-2000 RAN 110, the PSS 100 transmits a registration request message to the RAS 131, wherein the registration request message includes both IP assignment method information on an assignment method of an IP address in the CDMA-2000 RAN 110, and information on a currently assigned IP address. The registration request message includes IP assignment method information on a method by which an IP address has been assigned to the PSS 100, information on an IP address assigned to the PSS 100, ARQ information, IP version and vender ID information, etc.

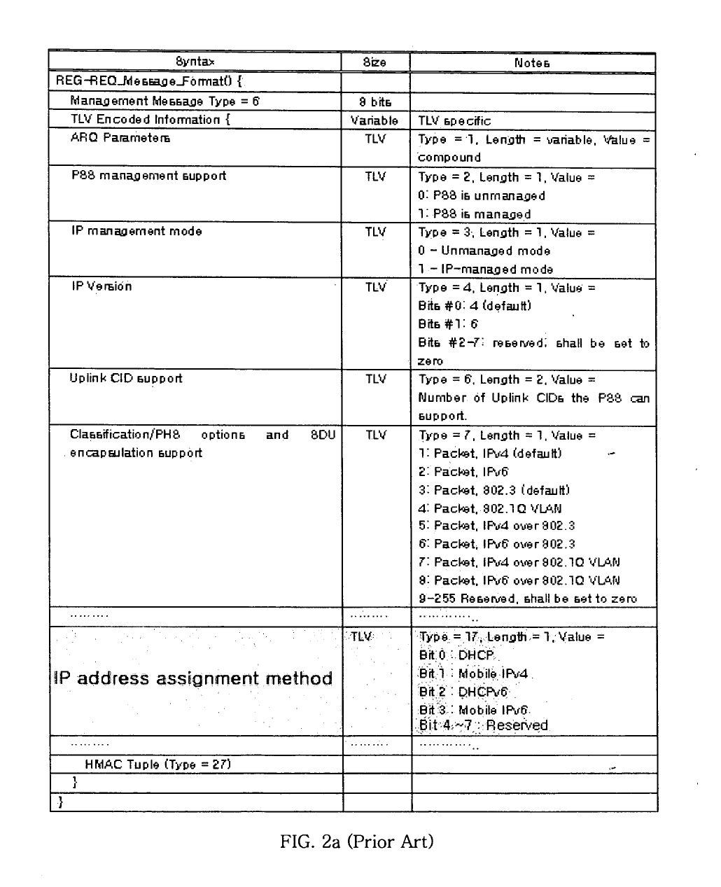

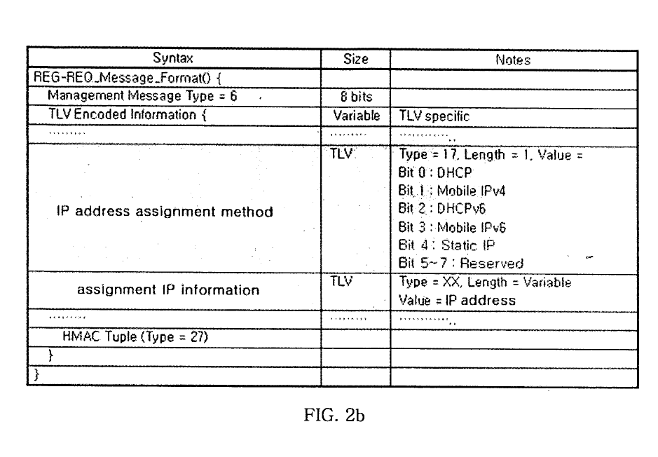

FIG. 2a is a diagram partially illustrating the format of a registration request message according to the prior art, and FIG. 2b is a diagram partially illustrating the format of a registration request message according to the preferred embodiment of the present invention.

Referring to the shaded portion of FIG. 2a, it can be understood that the registration request message according to the prior art also includes information on an IP address assignment method. The IP address assignment method may include a Dynamic Host Configuration Protocol (hereinafter, referred to as DHCP), a mobile Ipv4, a DHCPv6, a mobile Ipv6, etc. Referring to the field regarding the IP address assignment method in FIG. 2a, the field includes only information on an IP assignment method to be used by the PSS 100. However, according to the present invention, in a situation where handoff, etc., from the CDMA-2000 RAN 110 is required, the IP address having been used in the previous network is utilized in consideration of the continuity of a service, instead of reassigning an IP address. Accordingly, it is necessary to define a field regarding the use of a static IP address in the field regarding the IP address assignment method according to the prior art, and the field must include detailed information on the previous IP address.

The format of the registration request message proposed by the preferred embodiment of the present invention while taking this point into consideration is illustrated in FIG. 2b. Referring to FIG. 2b, the field regarding the use of the static IP address is defined in the field regarding the IP address assignment method. Further, the registration request message additionally includes an IP address information field having the type and length of an IP address, an actual IP address value, etc. The afore-described IP address information field may be an option field necessary only when the static IP address is used for the IP address assignment method.

As described above, the registration request message, having the format as illustrated in FIG. 2b according to the preferred embodiment of the present invention, is transmitted to the RAS 131, so that it is possible to use an IP address equal to that in the CDMA-2000 RAN 110, which is a network before interworking with the Portable Internet RAN 130, without reassignment of an IP address.

The PSS 100 according to the preferred embodiment of the present invention must utilize a dual stack in order to simultaneously use the Portable Internet network and the CDMA-2000 network according to the preferred embodiment of the present invention. Further, the PSS 100 must select a network, which the PSS 100 will access, according to network access conditions, and this is accomplished according to received signal levels. Further, data applications of the PSS 100 support static and dynamic mobile IP functions so that a service currently being provided is not terminated even when an access network is altered. Further, a Point to Point Protocol (hereinafter, referred to as PPP) setup in this process is applied only to a mobile telephone call such as a CDMA-2000, and is not applied to a Portable Internet call.

When the PSS 100 accesses the Portable Internet RAN 130 from the CDMA-2000 RAN 110, the PSS 100 can transfer network information on the CDMA-2000 RAN 110 to the Portable Internet RAN 130.

In the meantime, the PSS 100 according to the preferred embodiment of the present invention may include a PDA, a cellular phone, a Personal Communication Service (hereinafter, referred to as PCS) phone, a handheld PC, a GSM phone, a WCDMA phone, a CDMA-2000 phone, a Mobile Broadband System (hereinafter, referred to as MBS) phone, etc.

The BTS 111 according to the preferred embodiment of the present invention corresponds to a network endpoint equipment for directly interworking with stations, which performs a baseband signal processing, a wire/wireless conversion, transmission/reception of radio signals, etc. The BTS 111 accepts call attempt of the PSS 100 through a traffic channel of signal channels, and transmits the accepted call attempt to the BSC 112.

The BSC 112 according to the preferred embodiment of the present invention controls the BTS 111, and performs radio channel allocation and release for stations, transmit power control of stations and the BTS 111, determination of inter-cell soft handoff and hard handoff, transcoding and vocoding, a Global Positioning System (GPS) clock distribution, operation and maintenance for the BTS 111, etc.

The PCF 113 according to the preferred embodiment of the present invention is connected to the BSC 112 and the PDSN 121, and sets/maintains/releases connection with the PDSN 121. The PCF 113 requests the BSC 112 to assign radio resources for transmission of packet data, and collects accounting information and transmits the collected accounting information to the PDSN 121. Further, the PCF 113 performs a buffering function and a state management function of the PSS 100 until packet data received from the PDSN 121 are transmitted to the PSS 100.

If a handoff call is received from the Portable Internet RAN 130, the BSC 112 and the PCF 113 according to the preferred embodiment of the present invention look up an IP address for the ACR 132 by utilizing the access information of the Portable Internet RAN 130, and must acquire IP information or transfer the access information of the Portable Internet RAN 130 to the PDSN 121.

The PDSN 121 according to the preferred embodiment of the present invention performs a previous network identification function for the PSS 100, a PPP processing only for a CDMA 2000 call after discerning the CDMA 2000 call from a Portable Internet call, a DHCP server function for accomplishing an IP address assignment for the PSS 100, etc.

The HA 122 according to the preferred embodiment of the present invention performs routing for transmitting packets from an external packet data service server such as the Internet 140, and the AAA 123 performs accounting for packet data used by the PSS 100 in cooperation with the RAS 131, and authenticates access from the PSS 100.

The RAS 131 according to the preferred embodiment of the present invention transmits data, which are received from the ACR 132, to the PSS 100 in a wireless manner, and has a low power RF/IF module and controller function, an OFDMA/TDD packet scheduling and channel multiplexing function, a MAC frame variable control function according to service characteristics and radio wave conditions, a real-time control function of 50 Mbps grade high-speed traffic, a handoff function, etc.

If the PSS 100 accesses the Portable Internet RAN 130 from the CDMA-2000 RAN 110, the RAS 131 according to the preferred embodiment of the present invention receives the registration request message from the PSS 100, and transfers the registration request message to the ACR 132, wherein the registration request message includes the IP assignment method information on a method by which an IP address has been assigned to the PSS 100 in the CDMA-2000 RAN 110, and the information on an IP address assigned to the PSS 100.

The ACR 132 according to the preferred embodiment of the present invention corresponds to an access control router for accommodating the multiple RASs 131, has a handoff control function between the RASs 131, a handoff function between the ACRs 132, a packet routing function, an Internet access function, etc., and is connected to an IP network.

The ACR 132 according to the preferred embodiment of the present invention receives the IP address information included in the registration request message from the RAS 131, and registers the IP address, which is being used by the CDMA-2000 RAN 110, as the IP address of the PSS 100 in the Portable Internet RAN 130 by means of the received IP address information.

Further, the ACR 132 according to the preferred embodiment of the present invention must perform a function capable of discerning the originating call of the Portable Internet RAN 130 from a handoff call and processing the two types of calls. That is, the ACR 132 performs an IP-relating processing and data transmission for the originating call of the Portable Internet RAN 130, and supports connection with the PDSN 121 for the handoff call with the CDMA-2000 RAN 110. Furthermore, the ACR 132 according to the preferred embodiment of the present invention performs a Foreign Agent (FA) function for supporting a mobile IP operation.

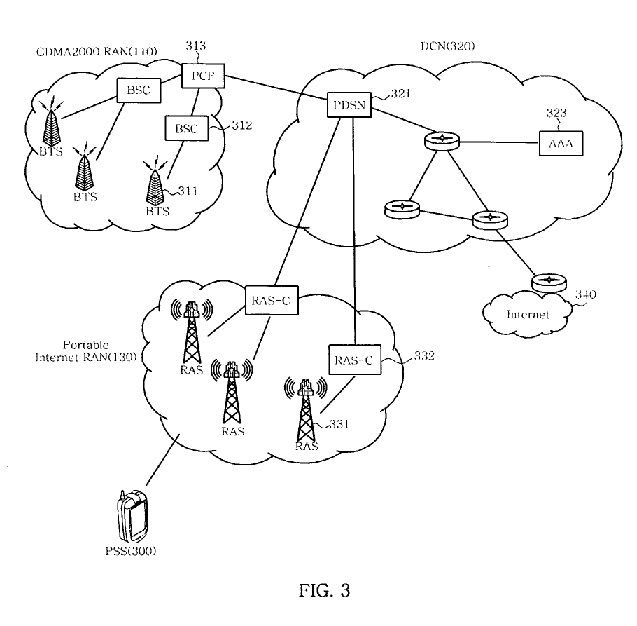

FIG. 3 is a block diagram illustrating a network structure for the tightly-coupled interworking scheme between a Portable Internet network and a different type of network according to the preferred embodiment of the present invention.

The tightly-coupled interworking scheme is based on that a CDMA-2000 RAN 310 and a Portable Internet RAN 330 interwork with each other by means of a simple IP address. A RAS-C 332 in FIG. 3 performs channel assignment and management of a RAS 331, and provides an interface for data call processing with a PDSN 321. Further, the PDSN 321 recognizes the RAS-C 332 as being identical to a BSC 313 of the CDMA-2000 RAN 310, and performs the data call processing.

The IP registration method described in FIG. 1 according to the preferred embodiment of the present invention may be applied to both the loosely-coupled interworking scheme and the tightly-coupled interworking scheme in the same manner. Accordingly, a description about FIG. 3 will be replaced with the description of FIG. 1.

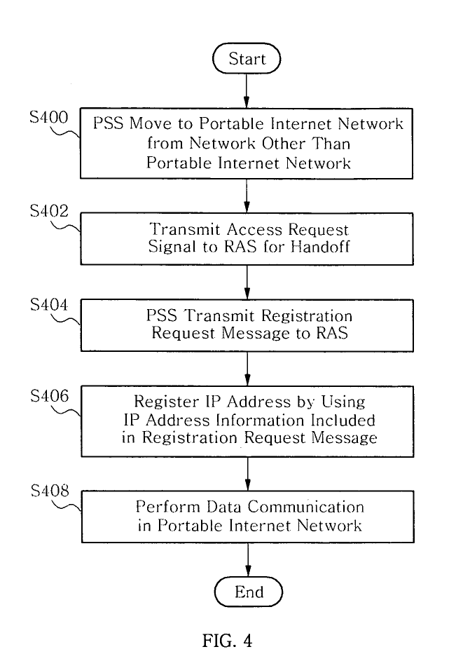

FIG. 4 is a flow diagram schematically illustrating a process for registering an IP address in a Portable Internet network when the Portable Internet network interworks with a different type of network according to the preferred embodiment of the present invention.

First, the PSS 100 accesses the Portable Internet RAN 130 from a different type of network such as the CDMA-2000 RAN 110 (S400). The PSS 100 transmits an access request signal to the RAS 131 for handoff (S402). Herein, the PSS 100 transmits the registration request message as described above to the RAS 131 (S404), wherein the registration request message includes the IP assignment method information on a method by which an IP address has been assigned to the PSS 100 in the different type of network, and the information (IP address information) on an IP address assigned to the PSS 100.

The RAS 131 having received the registration request message transmits the IP assignment method information and the IP address information, which are included in the registration request message, to the ACR 132, and the ACR 132 registers the existing IP address by means of the received information (S406). That is, the ACR 132 maintains the existing IP address, instead of newly assigning an IP address.

If the ACR 132 succeeds in registering the existing IP address, the PSS 100 performs data communication through a session established by the Portable Internet RAN 130 (S408).

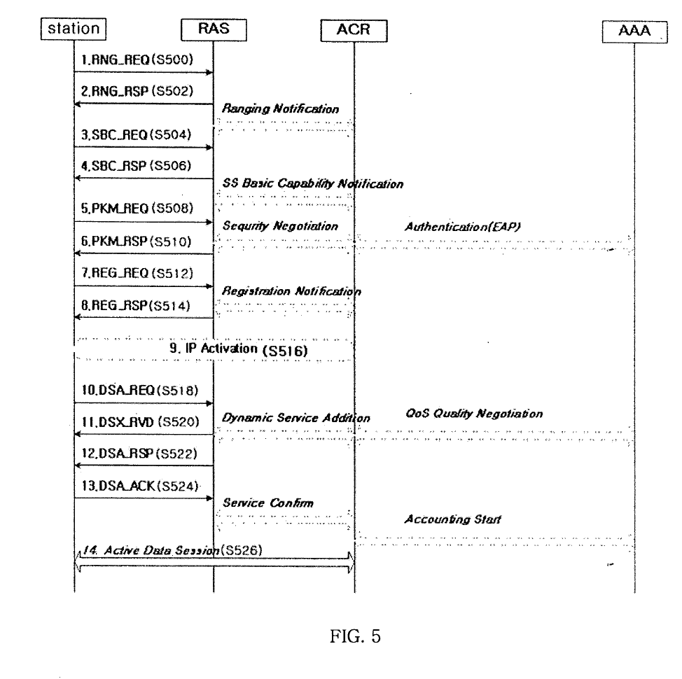

FIG. 5 is a ladder diagram illustrating an originating procedure on the PSS 100 when a Portable Internet network interworks with a different type of network according to the preferred embodiment of the present invention.

First, the PSS 100 transmits an access request signal to the RAS 131 by means of an initial ranging Connection ID (CID) (S500). The RAS 131 transmits related parameters to the PSS 100 so that the PSS 100 can acquire channel information necessary for communication from the RAS 131 (S502).

The PSS 100 transmits station capability information to the RAS 131 (S504). Herein, the station capability information includes the basic CID of the PSS 100, parameters supportable by a physical layer, supportable bandwidth assignment parameters, a supportable authentication policy, etc. The RAS 131 transmits capability information, which the RAS 131 can accept, of the capability information provided by the PSS 100, to the PSS 100 (S506).

The PSS 100 transmits security and authentication request including security association, an authentication request, a security key request, an EAP transmission request, etc., to the RAS 131 (S508) The RAS 131 transmits a response for the request of the PSS 100 in cooperation with the AAA server 123 (S510).

The PSS 100 transmits a registration request message including an ARQ, an IP management mode, an IP version, a vendor ID, IP assignment method information, IP address information, etc., to the RAS 131 (S512). Herein, the PSS 100 modifies the registration request message so as to be suitable for the Portable Internet RAN 130 by means of a Previous Access Network ID (PANID) for the CDMA-2000 RAN 110, and transfers the modified registration request message to the RAS 131. The RAS 131 transmits station capability information and vendor information, which are available by the RAS 131, to the PSS 100, together with success or failure of the registration request (S514).

As described above, the IP address used in the previous network is also utilized in the Portable Internet network by means of the IP assignment method information and the IP address information included in the registration request message, so that the PSS 100 can maintain the existing IP address, instead of receiving a new IP address (S516).

The PSS 100 transfers the traffic characteristics of a service flow, scheduling requirements, a service flow convergence sub-layer parameter standard, etc., to the RAS 131 in order to add the service flow (S518). The RAS 131 notifies the PSS 100 that the RAS 131 has received such information (S520).

Then, the RAS 131 transmits the service flow parameters of requested transaction and the detailed convergence sub-layer parameters of the service flow to the PSS 100 (S522), and the PSS 100 confirms reception of these parameters (S524). The PSS 100 performs data communication through a session established through the steps as described above (S526).

The interworking function according to the preferred embodiment of the present invention can be utilized regardless of the type of an interworking scheme such as the loosely-coupled interworking scheme and the tightly-coupled interworking scheme, which are described in the 3G-WLAN interworking scheme, and a smoothly-coupled interworking scheme having complemented these two interworking schemes.

According to the present invention as described above, when a Portable Internet network interworks with a different type of network, network interworking can be performed without change in an IP address used in a previous network, so that it is not necessary to change an IP address in a Portable Internet RAN. Accordingly, it is easy to construct the Portable Internet network. Further, a service continuity is maintained in handoff, so that it is possible to provide convenience to subscribers.

Although a preferred embodiment of the present invention has been described for illustrative purposes, those skilled in the art will appreciate that various modifications, additions and substitutions are possible, without departing from the scope and spirit of the present invention as disclosed in the accompanying claims.

1. A method for registering an IP address in a Portable Internet network when the Portable Internet network interworks with a different type of network, which enables a communication service to be continued without change in an Internet Protocol (IP) address of a personal subscriber station when the personal subscriber station moves from the different type of network to the Portable Internet network, the method comprising the steps of:
(a) when the personal subscriber station accesses the Portable Internet network from the different type of network, receiving a registration request message from the personal subscriber station, the registration request message including both information (IP assignment method information) on an IP assignment method by which an IP address has been assigned to the personal subscriber station in the different type of network, and IP address information on an IP address assigned to the personal subscriber station; and
(b) registering the IP address having been used by the different type of network as the IP address of the personal subscriber station in the Portable Internet network by means of the IP address information included in the registration request message.

2. The method as claimed in claim 1, wherein the personal subscriber station utilizes a dual stack for the simultaneous use of the Portable Internet network and the different type of network.

3. The method as claimed in claim 1, wherein the personal subscriber station supports a static mobile IP function, a dynamic mobile IP function and/or a simple IP function.

4. The method as claimed in claim 1, wherein the method is applied to a loosely-coupled interworking scheme and a tightly-coupled interworking scheme, the loosely-coupled interworking scheme corresponding to an interworking scheme in a case where the Portable Internet network and the different type of network are independent of each other, and the tightly-coupled interworking scheme corresponding to an interworking scheme in a case where the Portable Internet network is a lower access network of the different type of network.

5. The method as claimed in claim 1, wherein the personal subscriber station transfers network information on the different type of network when the personal subscriber station accesses the Portable Internet network.

6. The method as claimed in claim 1, wherein the registration request message includes at least one of the IP assignment method information, the IP address information, ARQ information, IP version and vender ID information.

7. The method as claimed in claim 1, wherein the IP assignment method information includes at least one of a Dynamic Host Configuration Protocol (DHCP), a mobile Ipv4, a DHCPv6, a mobile Ipv6 and a static IP.

8. The method as claimed in claim 1, wherein the IP address information is one of the options given the IP assignment method is a static IP.

9. The method as claimed in claim 1, wherein the different type of network includes a CDMA-2000 network, a Global System for Mobile (GSM) network, a Wideband CDMA (WCDMA) network or a Wireless Local Access Network (WLAN).

10. A system for registering an IP address in a Portable Internet network when the Portable Internet network interworks with a different type of network, which enables a communication service to be continued without change in an Internet Protocol (IP) address of a personal subscriber station when the personal subscriber station moves from the different type of network to the Portable Internet network, the system comprising:
a radio access station for receiving a registration request message from the personal subscriber station when the personal subscriber station accesses the Portable Internet network from the different type of network, the registration request message including both information (IP assignment method information) on an IP assignment method by which an IP address has been assigned to the personal subscriber station in the different type of network, and information (IP address information) on an IP address assigned to the personal subscriber station; and
an access control router for receiving the IP address information included in the registration request message from the radio access station, and registering the IP address being used by the different type of network as the IP address of the personal subscriber station in the Portable Internet network by means of the received IP address information.

11. The system as claimed in claim 10, further comprising the personal subscriber station for transmitting the registration request message to the radio access station when the personal subscriber station accesses the Portable Internet network from the different type of network, the registration request message including the IP assignment method information and the IP address information.

12. The system as claimed in claim 10, wherein the personal subscriber station utilizes a dual stack in order to simultaneously use the Portable Internet network and the different type of network.

13. The system as claimed in claim 10, wherein the personal subscriber station supports a static mobile IP function, a dynamic mobile IP function and/or a simple IP function.

14. The system as claimed in claim 10, wherein the system is applied to a loosely-coupled interworking scheme and a tightly-coupled interworking scheme, the loosely-coupled interworking scheme corresponding to an interworking scheme in a case where the Portable Internet network and the different type of network are independent of each other, and the tightly-coupled interworking scheme corresponding to an interworking scheme in a case where the Portable Internet network is a lower access network of the different type of network.

15. The system as claimed in claim 10, wherein the personal subscriber station transfers network information on the different type of network when the personal subscriber station accesses the Portable Internet network.

16. The system as claimed in claim 10, wherein the registration request message includes at least one of the IP assignment method information, the IP address information, ARQ information, IP version and vender ID information.

17. The system as claimed in claim 10, wherein the IP assignment method information includes at least one of a Dynamic Host Configuration Protocol (DHCP), a mobile Ipv4, a DHCPv6, a mobile Ipv6 and a static IP.

18. The system as claimed in claim 10, wherein the IP address information is one of the options when the IP assignment method is a static IP.

19. The system as claimed in claim 10, wherein the different type of network includes a CDMA-2000 network, a Global System for Mobile (GSM) network, a Wideband CDMA (WCDMA) network or a Wireless Local Access Network (WLAN).

20. The system as claimed in claim 10, wherein the access control router performs a foreign agent function for supporting a mobile IP operation.
